(19) United States
(12) Patent Application Publication
(10) Pub. No.: US 2010/0101499 A1
(43) Pub. Date: Apr. 29, 2010

(54) ANIMAL WATER BOWL

(76) Inventor: David John Michael Gibson, Wellington (NZ)

Correspondence Address: Say Systems Ltd, PO Box 17223, Karori, Wellington, 6147, omitted

(21) Appl. No.: 12/531,878

(22) PCT Filed: Mar. 20, 2008
(86) PCT No.: PCT/NZ08/00056

§ 371 Date: Sep. 18, 2009

(51) Int. Cl. A01K 7/00

(52) U.S. Cl. 119/61.5; 119/72

(57) ABSTRACT

Disclosed is a water bowl for animals, particularly pets such as cats and dogs. The water comprises a reservoir wherein the basin for accessing the water is formed within the centre of the reservoir. Water flow from the reservoir to the basin is controlled by a valve assembly.

### FIELD OF THE INVENTION

The present invention relates to an animal water bowl. More particularly, but not exclusively, the present invention relates to a stable and portable animal water bowl.

### BACKGROUND TO THE INVENTION

There exists in the prior art many different types of animal food bowls and water bowls. The combination water bottle and bowl disclosed in U.S. Pat. No. 6,101,974 discloses a system wherein the bowl stores water between the walls of the container within a bowl-shaped depression in the centre for water to be accessed by an animal. Included is a valve system for releasing the water from the storage compartment in the walls, to the recess. However U.S. Pat. No. 6,101,974 relies on manual activation to replenish the water in the bowl. Water only enters the bowl as the valve is manually released, thus the animal relies on the user for a steady supply of water.

The pet feeder device disclosed in the documents U.S. Pat. Nos. 7,077,074, 6,874,445, and 2004/0182326 includes a gravity feed system controlled by the pressure-equilibrium of the water storage vessel, and a valve system for releasing the flow of water. However in these documents the water is stored essentially in a separate vessel to the bowl that the animal uses to access the water. The water is stored only in the lid section which in use is raised above the bowl section. This combination of two parts is mechanically complicated and is not very stable when in use by an animal.

The portable pet bowl of U.S. Pat. No. 5,738,039 discloses a system for providing water to a pet, wherein the water is stored in a reservoir that may feed water to a bowl via a valve. The opening of the valve opens water access to the bowl compartment, while also opening air access to the reservoir, allowing free flowing of the water until the valve is closed. This system requires a user to manually provide water on demand to the animal, and the side-bowl arrangement is not very stable in use when unattended.

The watering device of U.S. Pat. No. 4,192,256 holds water in a reservoir portion which allows flow to a drinking cup portion through an aperture, relying on pressure-equilibrium to maintain the level of water. The aperture may be closed off with a bung, for transporting the device. The bung system for closing off the water access is quite cumbersome and is not readily accessible to the user. The side water-access is also not very stable in use.

The liquid dispenser of U.S. Pat. No. 3,076,435 is designed so that the walls of the container form the water reservoir, with a depression in the centre for an animal to access the water, and the water level is maintained by a pressure-equilibrium system. However there is no valve system for controlling the flow of the water into the recess for refilling and storage purposes. There is only one bung on top of the reservoir for adding water. Care would need to be taken when transporting this dispenser so that liquid would not spill out, or it would need to be emptied in advance.

The pet water bowls of the documents U.S. Pat. Nos. 5,960,740, 5,881,670 and 6,142,101 disclose a water bowl designed to reduce splash and spill of the liquid during use. This device uses a partition in the bowl to divide the main cavity into to chambers, such that the majority of the liquid is in the second chamber, which feeds liquid to the first chamber via an aperture. However there is no valve means to close off the aperture for transport of the device, thus it would need to be emptied first.

The vessel of U.S. Pat. No. 5,791,287 discloses an animal water bowl designed to reduce splash of the liquid by reducing the amount of liquid directly accessible to the animal. This is achieved by providing a floating dish on top of the liquid, whereby liquid flows up onto the dish through an aperture. However there is no valve means for closing off the supply of liquid for transport.

The bowl of U.S. Pat. No. 5,297,504 is designed for use by animals while they are being transported, such that shaking or bumping of the bowl doesn't splash the liquid out of the bowl. This is achieved by a baffle system in the bowl that redirects splashes back through apertures into the reservoir below the baffle. However there is no valve means to prevent the flow of the liquid back out of the bowl, thus during transport the bowl must be kept generally horizontal to prevent spilling.

The container of the document U.S. Pat. No. 6,668,579 discloses bowls with liquid storage between the inner and outer walls. The document includes cover particular details of the fill cap, the materials of construction and the thickness of the walls. However there is no mention of a animal water bowl use or system or valves to control the flow of the water.

### OBJECT OF THE INVENTION

It is an object of the invention to provide an animal water bowl that is stable during use and/or can securely contain water during transport, and/or at least provide the public with a useful choice.

### SUMMARY OF THE INVENTION

As used herein, the terms ‘animal water bowl’ and ‘water bowl’ refer to a bowl for containing a readily flowing liquid for consumption by an animal. This includes but is not limited to water, water based mixtures, and emulsions such as milk. Accordingly the term ‘water’ is used herein to refer to water or any water based liquid.

In one aspect the invention broadly consists in an animal water bowl comprising:
a water reservoir, wherein the structure of said reservoir includes an external recess forming a water basin;
an aperture for providing water flow between said reservoir and said basin;
a valve assembly for controlling said water flow through said aperture;

Preferably the reservoir, aperture and water basin are arranged such that in use, when the valve of the valve assembly is open, the pressure-equilibrium within said reservoir maintains the level of water in said water basin.

Preferably the valve assembly includes two alterable positions, wherein a first alterable position closes off the water flow from the reservoir to the basin providing a contained water-tight reservoir, and a second alterable position allows water flow from the reservoir to the water basin.

Preferably the reservoir comprises a further water inlet.

Preferably said water inlet includes a sealing cap.

Preferably said sealing cap is a component of the valve assembly.

Preferably the valve assembly includes a rotating valve member for controlling the water flow from the reservoir to the water basin.

More preferably the valve assembly includes a rotating valve member for controlling the water flow from the reservoir to the water basin; and
in use the sealing cap rotatably engages with said rotating valve member.

Preferably the reservoir includes a removable portion that when removed enables access to said reservoir for cleaning.

Preferably the removable portion is a base portion of the reservoir.

Preferably the animal water bowl further comprises a water filter.

More preferably a water filter is located between the reservoir and the water basin, such that in use water flowing from the reservoir to the water basin passes through the water filter.

Preferably the water reservoir is substantially toroidal shaped.

Preferably a further bowl is included that is adapted to locate in the water basin.

Another aspect of the invention broadly consists in a bowl stabilising device comprising a generally toroidal shaped container, wherein the centre of said container is adapted for holding a bowl.

Preferably the generally toroidal shaped container includes at least one hollow portion that may be filled with water via at least one removable cap.

Another aspect of the invention broadly consists in a method of stabilising a food bowl, wherein the food bowl is placed in the centre of a toroidal-shaped container which is adapted for holding a bowl.

Preferably the generally toroidal shaped container includes at least one hollow portion that may be filled with water via at least one removable cap.

### BRIEF DESCRIPTION OF THE FIGURES

Preferred forms of the invention will now be described with reference to the accompanying figures in which:

FIG. 1 shows a top view of a preferred embodiment;

FIG. 2 shows an isometric view of the top half of a preferred embodiment;

FIG. 3 shows an isometric view of the bottom half of a preferred embodiment;

FIG. 4 shows a section-view of a preferred embodiment;

FIG. 5 shows an isometric section-view of a preferred embodiment;

FIG. 6 shows a side view of internal components of the valve assembly of a preferred embodiment;

FIG. 7 shows an exploded view of a preferred embodiment;

FIG. 8 shows an isometric view of a preferred embodiment;

FIG. 9 shows a top view of a preferred embodiment;

FIG. 10 shows an exploded view of a preferred embodiment;

FIG. 11 a section-view of a preferred embodiment;

FIG. 12 shows an isometric section-view of a preferred embodiment;

FIG. 13 shows a side view of a valve assembly of a preferred embodiment;

### DETAILED DESCRIPTION OF THE PREFERRED EMBODIMENTS

### Preferred Embodiments

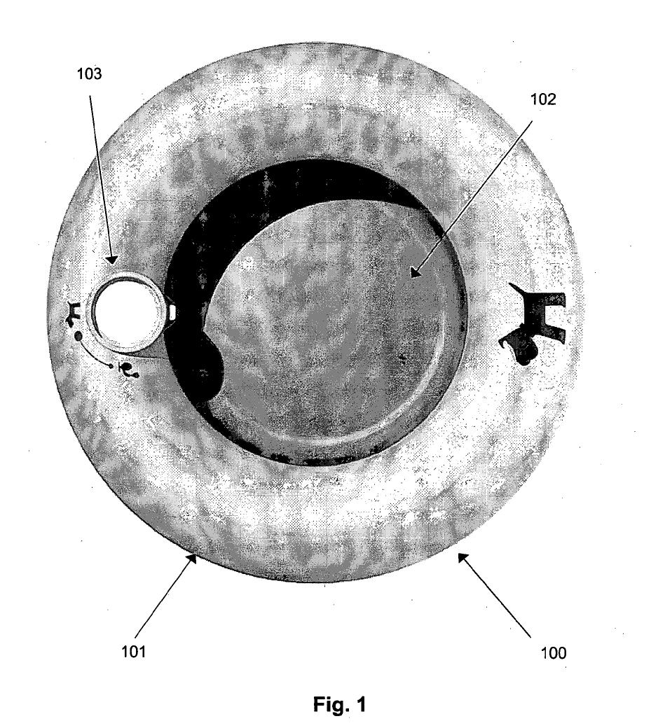

In reference to the figures, the preferred embodiment of the animal water bowl will be illustrated by way of non-limiting example. FIG. 1 shows a top view of a water bowl 100, which in this embodiment is generally toroidal in shape, wherein the reservoir 101 is formed from interior volume of the torus, although it is to understood that there is no shape limitation on the water bowl of the present invention. The water basin for the liquid to be accessed by the animal is in the centre of the bowl in a cavity bounded by the toroidal ring, with an integral base portion. Locating the water basin in the centre of the bowl and having the reservoir around the basin at a relatively low centre of gravity increases the stability of the bowl in use. A flange 103 is provided around an aperture in the top of the water bowl to locate the valve assembly (not shown in FIG. 1).

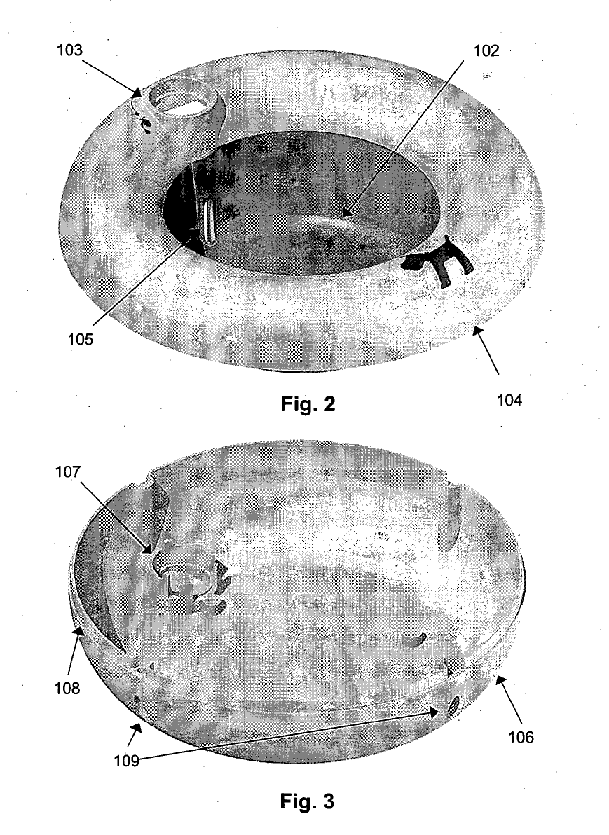

FIG. 2 shows an isometric view of the top half 104 of the reservoir and water basin of the water bowl, wherein the aperture 105 from the reservoir to the basin is shown. The height of this aperture determines the height of the liquid-level within the water basin while in use.

FIG. 3 shows an isometric view of the bottom half 106 of the reservoir, wherein the seat 107 of the valve assembly is shown. Also shown is the flange 108 on the outer surface of the bottom half of the reservoir, which interlocks with the top half 104 to provide a water tight seal. Preferably a further sealing means such as an o-ring or gasket is also used to ensure a water tight seal. Various means for holding the two halves 104 and 106 together are possible, such as clips, bolts, and screws. Shown are holes 109 for fastening means such as screws or bolts.

The reservoir, including the water basin, may be formed from any suitable material, preferably from a food-grade polymer, more preferably from food-grade polypropylene. In the preferred embodiment the reservoir is formed in two halves 104 and 106 by molding techniques, such as injection molding, blow molding, and thermoforming. Preferably injection molding of food-grade polypropylene is used to form the two halves 104 and 106, which may be detachably joined together using fasteners. In alternative embodiments the hollow reservoir could be formed as one piece, using techniques such as rotational molding.

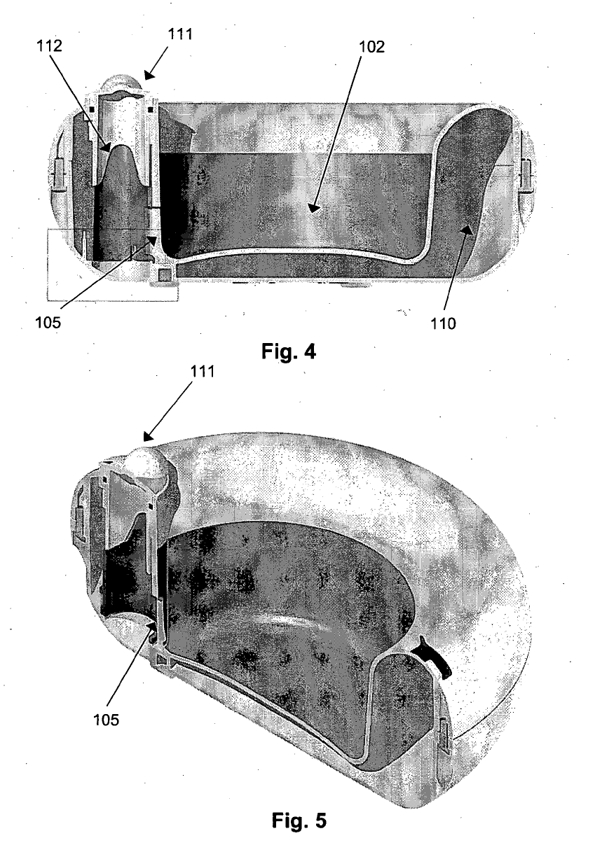

In FIG. 4 and FIG. 5 a cross-sectional view of an assembled water bowl is shown, wherein the reservoir formed within the top and bottom halves is visible, and details of the valve assembly are also shown.

As clearly seen in FIG. 4, the base of the cavity defining the water basin of the preferred embodiment is convex, which provides further rigidity and support. The reservoir also extends underneath the water basin, which assists in keeping a low centre of gravity, and greater stability.

In the preferred embodiment the valve assembly includes elements, particularly the valve body, molded into the reservoir's components. In alternative embodiments the valve assembly may comprise entirely separate components that fit into the reservoir and/or water basin to control flow of water to the basin.

In the preferred embodiment, the valve assembly functions as a plug valve, wherein the generally cylindrical plug 112 rotates within the valve body. The valve body is formed by the combination of the valve seat 107 within the lower half of the reservoir and the flange section 103 on the top half of the reservoir. The valve is in an open state when the port in the lower part of the valve plug 112 lines up with the aperture 105 between the reservoir and the water basin. When the port in the valve plug 112 does not line up with the aperture 105, the valve is in the closed position.

The sealing cap 111 meshes with the valve plug 112, so that rotating the sealing cap also rotates the valve plug. The sealing cap 111 is removable so that the reservoir can be filled or emptied. When the valve is in the closed position, which may also be described as the fill position, flow of water from the reservoir 110 to the water basin 102 is shut off. When the valve is in this off position and the sealing cap 111 is removed, liquid may be poured through the opening 103 and into the reservoir without liquid entering the water basin. Alternatively liquid may be poured through the opening when the valve is in the on position, which would result in the reservoir being filled and the water basin being filled, although the water basin may be filled to a higher level than the usual water level maintained by the height of the aperture 105.

Accordingly after filling the reservoir, the sealing cap should be replaced to seal the reservoir 110, such that the only opening is through the aperture 105 to the water basin. When the reservoir is filled and the valve is opened the liquid in the water basin 102 will be continuously replenished to the height of the aperture 105 as long as there is liquid in the reservoir.

The pressure-equilibrium within the reservoir prevents water flowing out above the height of the aperture 105, due to the potential vacuum force within the reservoir, wherein a vacuum would be created if water flowed out of the reservoir and into the water basin and air was unable to enter through the aperture.

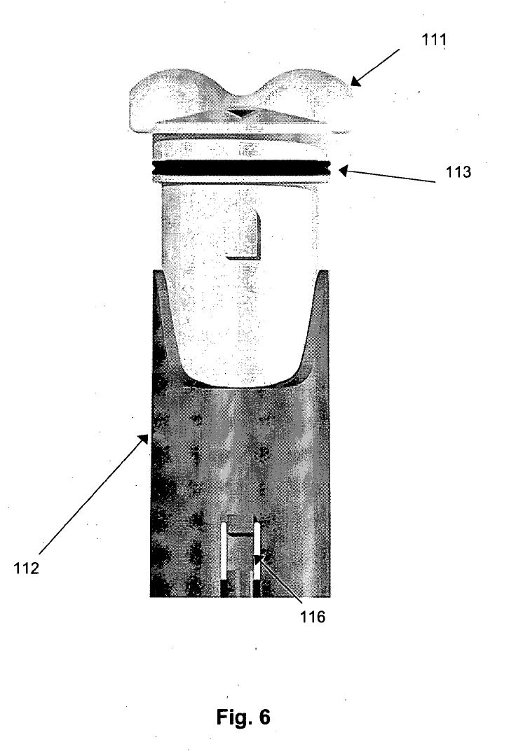

The internal components of the valve assembly of the preferred embodiment are shown in FIG. 6, wherein the upper portion is the removable sealing cap 111, which includes a rubber seal 113 to provide a water tight seal when the cap is in place. The lower portion is the valve plug 112, which engages with the sealing cap 111. A clip 116 is included on the lower part of the valve plug 112 to retain and locate the valve plug in the valve body.

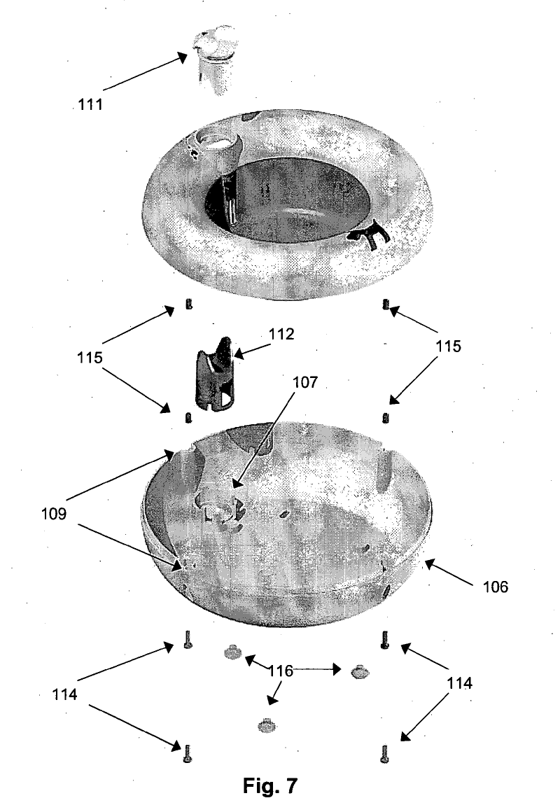

An exploded view of the preferred embodiment of the animal water bowl is shown in FIG. 7. The fastening means are machine screws, which engage with metal threaded inserts 115 that are seated into the plastic screw holes 109 of the top and bottom halves. Alternatively the screws may be threaded directly into the plastic, or into nuts located in the fastening holes. Alternative methods of fastening include the top and bottom halves directly attaching to one another with clips, or by a central portion of each being threaded so that the halves screw directly on one another. Alternatively a single central attachment threaded attachment means, such as a single screw or wingnut may be used for greater ease of removal and separating of the halves.

Preferably the fastening means can be released to provide access to the inside of the reservoir for cleaning. This feature allows a user to more easily provide a cleaner, healthier environment for an animal.

In the preferred embodiment the base of the bottom section 106 includes recesses that accept non-slip rubber feet 116, which add further stability during use. Alternatively other methods of reducing slip can be used, such as a non-slip pad that is either attached to the underside of the water bowl, or the water bowl is simply placed on the non-slip pad.

The size and type of animal that the water bowl is intended for will influence the shape and size of the water bowl. Larger animals will require a larger water bowl to hold sufficient water, while smaller animals will require a smaller or lower water bowl that enables the animal to easily access the water. The shape also needs consideration, as a large dog will more easily be able to access the centre of the torus shaped bowl of FIG. 1 than will a cat. Moreover a cat does not require the same level of stability of water bowl as a large dog, thus a less optimal design will still be suitable. As a way of improving access to the water for smaller animals, the cavity defining the water basin can be placed away from the centre of the reservoir. This provides at least one position around the exterior of the water bowl that the water basin is more easily accessed. As an example the embodiment shown in FIG. 1 can be modified by moving the centre of the water basin to form an eccentric generally toroidal shaped bowl. This will result in a portion of the outer reservoir having a smaller diameter than the remainder of the reservoir. A smaller animal, such as a cat, may find access to the water basin easier at the thinner and/or lower portion. Although the centre of gravity is slightly shifted away from the geometric centre of the water bowl, the slight reduction in stability is compensated for by the improved access for a smaller animal. Another embodiment comprises an oval shaped water bowl, wherein at least one of the acute ends of the oval reservoir is thinner and/or lower in height to provide easier access to the water basin. In another embodiment one portion of reservoir can be of a lower height, to enable easier access to the water basin.

Preferably the water bowl includes a water filter. The water filter can be located in the reservoir so that the water is filtered over time while in the reservoir. Alternatively the filter can be located in the inlet port of the reservoir so that the water is filtered as the reservoir is filled, although this can slow the fill rate of the reservoir. Preferably the filter is located between the reservoir and the water basin, so the water is filtered as the water enters the basin from the reservoir.

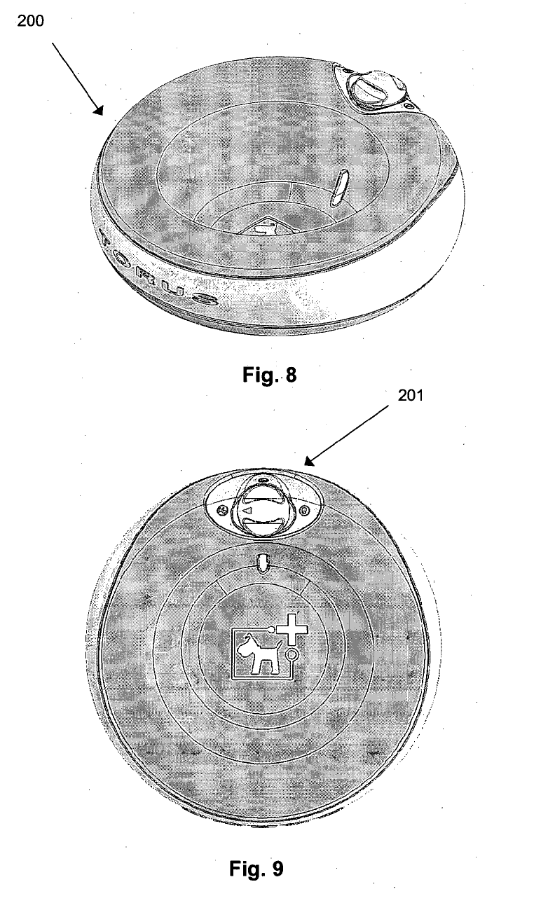

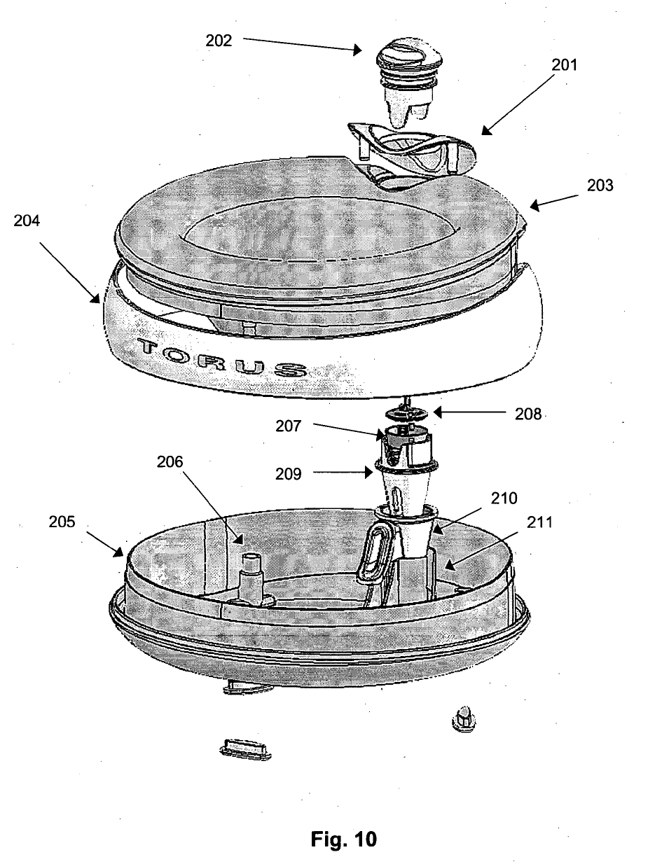

Another preferred embodiment of the invention 200 is shown in FIG. 8. A top view of this embodiment is shown in FIG. 9. In this embodiment the valve components are designed for rotating into three different positions, as displayed on the exterior of the valve cap surround 201. The exploded view of FIG. 10 shows the sealing cap 202, which engages with the valve plug 209 that is rotatable within the valve body 210. The valve body 210, which includes the water outlet, locates in the valve seat 211 of the base portion 205. Also included in this embodiment is a filter 207, that has a filter cap 208 which attaches to the top. The filter cap 208 includes a protruding stem that can be grasped by a user for removing the filter from the valve assembly. The upper portion 203 of the bowl attaches to the base portion 205 by fastening means such as screws of bolts via at least one attachment point 206. An exterior display component 204 is included in this embodiment that is attached around the perimeter of the water bowl. This display component can be used for branding purposes, or for customising or personalising the water bowl. The display component may be designed to be easily replaced, so that a user may choose the component they prefer. This provides opportunities for customising the water bowl with, for example; different coloured display components, or with the name of the pet animal that the bowl is for.

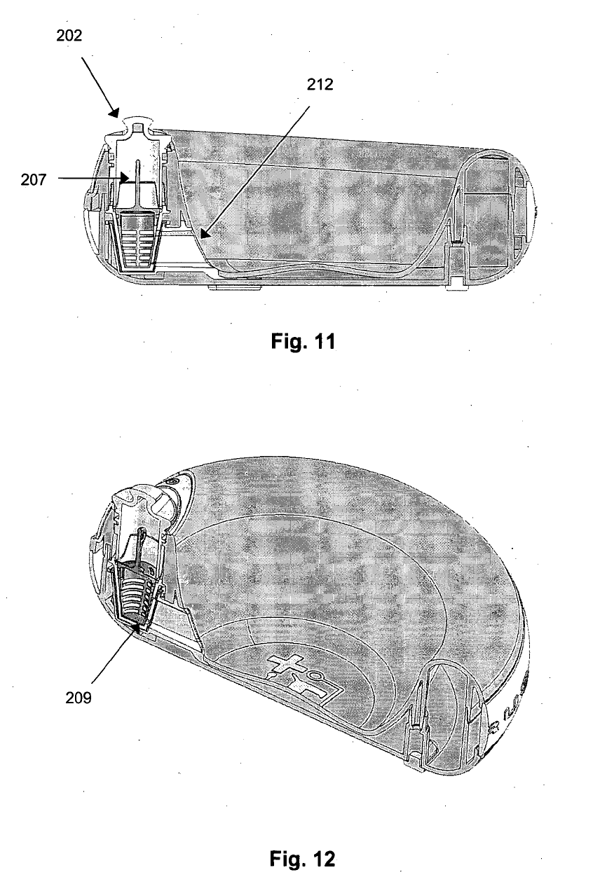

A cross-section of this embodiment of the water bowl is shown in FIGS. 11 and 12. In this embodiment the height of the bowl wall is less on the side opposite where the valve assembly is located. This allows for easier access to the basin for smaller animals. The shape of the sealing cap is preferably designed so that a user may grasp it to remove the sealing cap from the valve assembly for filling or emptying of the reservoir. When the reservoir is to be filled or emptied, the user may remove the filter by grasping the protruding stem of the filter cap 207. In use the water from the reservoir passes through the filter and into the basin via the outlet aperture 212. As can be seen in FIG. 12, the valve assembly is in the ‘on’ position that allows water to flow into the basin. The aperture port 209 of the valve is aligned with the outlet aperture. As would be appreciated by a person skilled in the art there are various configurations of valve designs and valve apertures that may be used. In one preferred embodiment the valve is configured so that in an ‘on’ position a first valve aperture is aligned with the outlet aperture to allow water to flow from the valve to the basin, while a second valve aperture is aligned with a reservoir aperture to allow water to flow from the reservoir to the valve. When the valve is then rotated to a ‘fill’ position the first valve aperture is no longer aligned with the outlet aperture, but it is now aligned with the reservoir aperture. This allows water to be poured in through the valve assembly with the sealing cap removed, to fill the reservoir without filling the basin. A third alignment may also be used in which no water flows through the valve, and optionally tabs or protrusions on the sealing cap are aligned so that the cap can not be removed. In this alignment the valve would be in a ‘locked’ position.

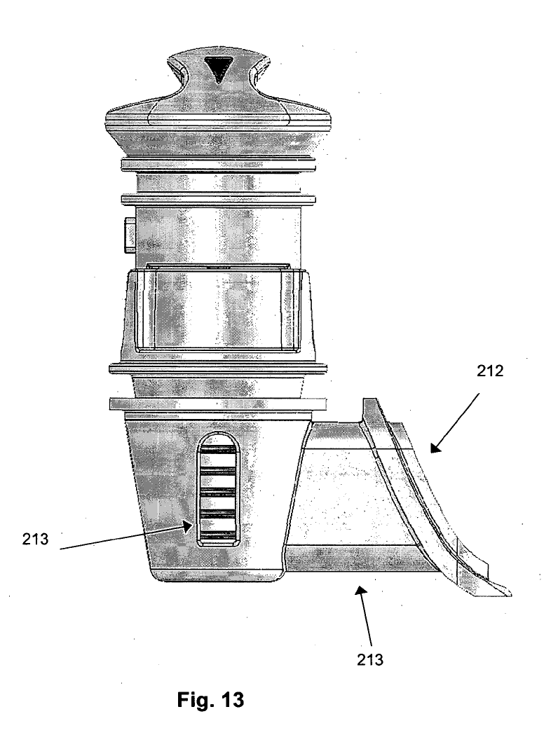

FIG. 13 shows the valve assembly of a preferred embodiment of the invention, wherein a valve aperture 213 allows water to flow into the valve passing through the filter. In this embodiment the valve assembly includes a protruding channel that directs flow of the water to the outlet aperture 212 that leads to the basin.

As an additional component, a further separate bowl may be included that is designed to fit within the cavity defining the water basin of the water bowl. The further bowl may be for use as a food bowl that on its own may be prone to being moved around or knocked over by an animal during use. Placing such a food bowl within the water bowl of the present invention adds further stability to the food bowl without requiring the food bowl to have the extra bulk of the water bowl. The food bowl may be prepared from any suitable material, including the same material as the water bowl. Preferably a more aesthetic material such as ceramic or porcelain may be used as the food bowl. In use if water is retained in the water basin and the food bowl is placed into the water basin, the water surrounding the food bowl can be useful as a deterrent to crawling insects, such as ants, that may attempt to reach the food bowl.

In an alternative embodiment, a container may be produced of the same general shape as the water bowl shown in FIGS. 1 to 5, except it does not include a valve, or aperture providing water flow from the reservoir to the basin. Instead the reservoir may be filled with water to add extra weight when in use, and a further bowl such as the food bowl described above may be placed in the cavity defining the basin of the container. The purpose of the bowl in this embodiment is to provide stability to a food bowl, to help prevent the food bowl being knocked over or moved out of position by an animal when feeding. In this embodiment, the container such as a toroidal shaped bowl similar to that shown in FIGS. 1 to 5, may be equipped with a single water inlet with a cap, so that the reservoir formed by the torus may be filled with water to provide the weight and stability. In use a further bowl, such as a food bowl is placed in the centre, whereby said food bowl is significantly more stabilised.

1. An animal water bowl comprising:
a water reservoir, wherein the structure of said reservoir includes an external recess forming a water basin;
an aperture for providing water flow between said reservoir and said basin; and
a valve assembly for controlling said water flow through said aperture.

2. The animal water bowl of claim 1, wherein the reservoir, aperture and water basin are arranged such that in use, when the valve of the valve assembly is open, the pressure-equilibrium within said reservoir maintains the level of water in said water basin.

3. The animal water bowl of claim 1 or 2, wherein the valve assembly includes two alterable positions, wherein a first alterable position closes off the water flow from the reservoir to the basin providing a contained water-tight reservoir, and a second alterable position allows water flow from the reservoir to the water basin.

4. The animal water bowl of any one of claims 1 to 3, wherein the reservoir comprises a further water inlet.

5. The animal water bowl of any one of claims 1 to 4, wherein said water inlet includes a sealing cap.

6. The animal water bowl of any one of claims 1 to 5, wherein said sealing cap is a component of the valve assembly.

7. The animal water bowl of any one of claims 1 to 6, wherein the valve assembly includes a rotating valve member for controlling the water flow from the reservoir to the water basin.

8. The animal water bowl of any one of claims 1 to 6, wherein the valve assembly includes a rotating valve member for controlling the water flow from the reservoir to the water basin; and
in use the sealing cap rotatably engages with said rotating valve member.

9. The animal water bowl of any one of claims 1 to 8, wherein the reservoir includes a removable portion that when removed enables access to said reservoir for cleaning.

10. The animal water bowl of claim 9; wherein said removable portion is a base portion of the reservoir.

11. The animal water bowl of any one of claims 1 to 10, further comprising a water. filter.

12. The animal water bowl of any one of claims 1 to 10, wherein a water filter is located between the reservoir and the water basin, such that in use water flowing from the reservoir to the water basin passes through the water filter.

13. The animal water bowl of any one of claims 1 to 12, wherein the water reservoir is substantially toroidal shaped.

14. The animal water bowl of any one of claims 13, wherein the diameter of the torus portion of the reservoir varies around the circumference of said torus portion.

15. The animal water bowl of any one of claims 1 to 14, wherein the centre of the water basin is located away from the centre of the water bowl.

16. The animal water bowl of any one of claims 1 to 15, wherein a further bowl is included that is adapted to locate in the water basin.

17. A water bowl as substantially herein described with reference to the figures and/or examples.
